(19) United States
(12) Patent Application Publication
(10) Pub. No.: US 2025/0039534 A1
(43) Pub. Date: Jan. 30, 2025

(54) IMAGING METHOD, IMAGING APPARATUS, AND PROGRAM

(71) Applicant: FUJIFILM Corporation, Tokyo (JP)

(72) Inventor: Yuma KOMIYA, Saitama-shi (JP)

(73) Assignee: FUJIFILM Corporation, Tokyo (JP)

(21) Appl. No.: 18/893,987

(22) Filed: Sep. 24, 2024

Related U.S. Application Data
(63) Continuation of application No. PCT/JP2023/005308, filed on Feb. 15, 2023.

(30) Foreign Application Priority Data
Mar. 29, 2022 (JP) 2022-054512

(51) Int. Cl. H04N 23/611; H04N 23/67; H04N 23/71; H04N 23/73; H04N 23/76

(52) U.S. Cl. CPC H04N 23/611; H04N 23/672; H04N 23/71; H04N 23/73; H04N 23/76

(57) ABSTRACT

According to an imaging method of the present disclosure, there is provided the imaging method including: an imaging step of generating image data by performing imaging through an imaging lens; a detection step of detecting a first subject and a second subject from the image data; a first focusing step of focusing on the first subject; and an adjustment step of performing imaging adjustment in the imaging step based on a state of the second subject.

### CROSS-REFERENCE TO RELATED APPLICATION

This application is a continuation application of International Application No. PCT/JP2023/005308, filed Feb. 15, 2023, the disclosure of which is incorporated herein by reference in its entirety. Further, this application claims priority from Japanese Patent Application No. 2022-054512 filed on Mar. 29, 2022, the disclosure of which is incorporated herein by reference in its entirety.

### BACKGROUND

### 1. Technical Field

The technology of the present disclosure relates to an imaging method, an imaging apparatus, and a program.

### 2. Description of the Related Art

JP2021-125735A discloses an imaging control device including a detection unit that can detect a subject of a plurality of types including a first type and a second type from a captured image, a switching unit that switches a type to which the predetermined process is performed from any of the first type and the second type, a selection unit that can select any subject of a plurality of the second types of the detected subjects from the captured image, and a control unit. The control unit displays the first subject of the first type in a first display form and displays the second subject of the second type in a second display form in a case where the type to which the predetermined process is performed is switched to the first type by the switching unit, and displays the second subject in the first display form in accordance with switching of the type to which the predetermined process is performed by the switching unit to the second type from the first type.

WO02020/080037A discloses an imaging apparatus comprising an imaging unit, a display unit, a first and second detection units, and a control unit. The imaging unit images a subject to generate a captured image. The display unit displays the captured image. In a case where the subject is a person, a first detection unit detects at least a part of the person. In a case where the subject is the animal, a second detection unit detects at least a part of the animal. The control unit controls a display unit to display a first detection frame corresponding to the person and a second detection frame corresponding to the animal on a captured image. The control unit controls a display unit such that the first detection frame and the second detection frame are displayed in a common display aspect in a case where the first detection frame and the second detection frame are not a third detection frame corresponding to a main subject among the subjects.

### SUMMARY

One embodiment according to the technology of the present disclosure provides an imaging method, an imaging apparatus, and a program capable of improving accuracy on an imaging adjustment.

In order to achieve the above object, according to an imaging method of the present disclosure, there is provided the imaging method including: an imaging step of generating image data by performing imaging through an imaging lens; a detection step of detecting a first subject and a second subject from the image data; a first focusing step of focusing on the first subject; and an adjustment step of performing imaging adjustment in the imaging step based on a state of the second subject.

The state is brightness, and it is preferable to adjust exposure in the adjustment step.

It is preferable that the adjustment step includes a determination step of determining whether or not an imaging environment is a specific imaging environment based on the brightness of the second subject, and in the adjustment step, the exposure is adjusted based on a determination result in the determination step.

In the adjustment step, it is preferable that the exposure is adjusted by prioritizing the brightness of the second subject over brightness of the first subject.

In the adjustment step, it is preferable that the exposure is adjusted such that a difference between brightness of the first subject and the brightness of the second subject after the exposure adjustment is within a predetermined range.

In the adjustment step, a tone of the image data may be adjusted.

In the detection step, it is preferable that the first subject and the second subject are detected by using a machine-trained model.

It is preferable that the first subject and the second subject are subjects of different types.

It is preferable that the second subject is a human, and the first subject is a subject other than the human.

It is preferable that the imaging method further includes a second focusing step of focusing on the second subject; and a selection step of selecting the first focusing step or the second focusing step, in which in the adjustment step, the imaging adjustment is performed based on the state of the second subject even in a case where any of the first focusing step or the second focusing step is selected.

According to an aspect of the present disclosure, there is provided an imaging apparatus comprising a processor in which the processor performs imaging processing of generating image data by performing imaging through an imaging lens, detection processing of detecting a first subject and a second subject from the image data, first focusing processing of causing the imaging lens to focus on the first subject, and adjustment processing of performing imaging adjustment in the imaging processing based on a state of the second subject.

According to an aspect of the present disclosure, there is provided a program causing a computer to execute: imaging processing of generating image data by performing imaging through an imaging lens; detection processing of detecting a first subject and a second subject from the image data; first focusing processing of focusing on the first subject; and adjustment processing of performing imaging adjustment in the imaging processing based on a state of the second subject.

### BRIEF DESCRIPTION OF THE DRAWINGS

Exemplary embodiments according to the technique of the present disclosure will be described in detail based on the following figures, wherein:

FIG. 1 is a diagram illustrating an example of a configuration of an imaging apparatus,

FIG. 2 is a diagram illustrating an example of a light-receiving surface of an imaging sensor,

FIG. 3 is a block diagram illustrating an example of a functional configuration of a processor,

FIG. 4 is a diagram conceptually illustrating an example of processing using a machine-trained model,

FIG. 5 is a diagram conceptually illustrating an example of processing by a distance measurement unit,

FIG. 6 is a diagram conceptually illustrating an example of processing by a photometry unit,

FIG. 7 is a diagram conceptually illustrating an example of processing in a case in which a second subject is selected as an AF target and an AE target,

FIG. 8 is a flowchart illustrating an example of an imaging operation by the imaging apparatus,

FIG. 9 is a diagram conceptually illustrating a photometry processing according to a modification example,

FIG. 10 is a flowchart illustrating adjustment processing according to the modification example,

FIG. 11 is a block diagram illustrating a functional configuration of a processor according to the modification example,

FIG. 12 is a flowchart illustrating an example of an imaging operation by the imaging apparatus according to the modification example,

FIG. 13 is a flowchart illustrating an example of determination processing by the backlight determination unit, and

FIG. 14 is a flowchart illustrating an example of adjustment processing in a case of performing backlight determination.

### DETAILED DESCRIPTION

An example of an embodiment according to the technology of the present disclosure will be described with reference to the accompanying drawings.

First, the terms to be used in the following description will be described.

In the following description, “AF” is an abbreviation for “auto focus”. “MF” is an abbreviation for “manual focus”. “AE” is an abbreviation for “auto exposure”. “IC” is an abbreviation for “integrated circuit”. “CPU” is an abbreviation for “central processing unit”. “ROM” is an abbreviation for “read only memory”. “RAM” is an abbreviation for “random access memory”. “CMOS” is an abbreviation for “complementary metal oxide semiconductor”.

“FPGA” is an abbreviation for “field programmable gate array”. “PLD” is an abbreviation for “programmable logic device”. “ASIC” is an abbreviation for “application specific integrated circuit”. “OVF” is an abbreviation for “optical view finder”. “EVF” is an abbreviation for “electronic view finder”.

As one embodiment of an imaging apparatus, the technology of the present disclosure will be described by using a lens-interchangeable digital camera as an example. Note that the technology of the present disclosure is not limited to the lens-interchangeable type and can also be applied to a lens-integrated digital camera.

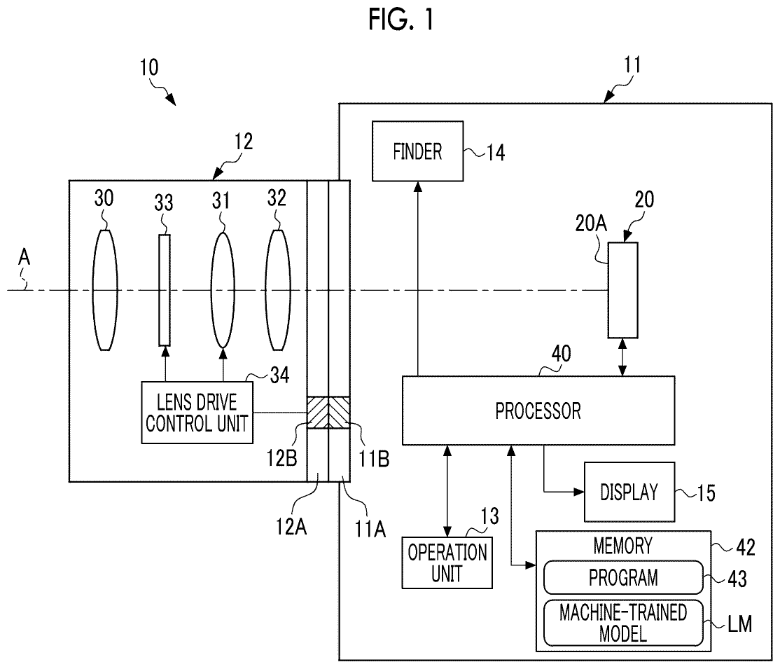

FIG. 1 illustrates an example of a configuration of an imaging apparatus 10. The imaging apparatus 10 is a lens-interchangeable digital camera. The imaging apparatus 10 includes a body 11 and an imaging lens 12 that is interchangeably mounted on the body 11 and includes a focus lens 31. The imaging lens 12 is attached to a front surface side of the body 11 via a camera side mount 11A and a lens side mount 12A.

The body 11 is provided with an operation unit 13 including a dial, a release button, and the like. The operation modes of the imaging apparatus 10 include, for example, a still image imaging mode, a video imaging mode, and an image display mode. The operation unit 13 is operated by a user upon setting the operation mode. In addition, the operation unit 13 is operated by the user in a case where the execution of the still image imaging or the video imaging is started.

In addition, the operation unit 13 is operated by the user in a case of selecting a focusing mode. The focusing mode includes an AF mode and an MF mode. The AF mode is a mode in which the focusing control is performed with respect to an AF area within the angle of view. The user can set the AF area by using the operation unit 13. The MF mode is a mode in which the user manually performs focusing control by operating a focus ring (not illustrated). In the AF mode, automatic exposure (AE) control is performed. In addition, the imaging apparatus 10 may be configured to allow the user to set the AF area via the display 15 having a touch panel function or the finder 14 having a visual line detection function.

In addition, the imaging apparatus 10 is provided with a subject automatic detection mode in which a plurality of subjects included within an angle of view are automatically detected. For example, in a case where the subject automatic detection mode is set in the AF mode, the subject closest to the currently set AF area is selected as an AF target among the plurality of detected subjects.

Further, the body 11 is provided with a finder 14. Here, the finder 14 is a hybrid finder (registered trademark). The hybrid finder refers to, for example, a finder in which an optical view finder (hereinafter, referred to as “OVF”) and an electronic view finder (hereinafter, referred to as “EVF”) are selectively used. The user can observe an optical image or a live view image of a subject projected onto the finder 14 via a finder eyepiece portion (not illustrated).

In addition, a display 15 is provided on a rear surface side of the body 11. An image based on image data obtained by imaging and various menu screens and the like are displayed on the display 15. The user can also observe the live view image projected onto the display 15 instead of the finder 14.

The body 11 and the imaging lens 12 are electrically connected to each other through contact between an electrical contact 11B provided on the camera side mount 11A and an electrical contact 12B provided on the lens side mount 12A.

The imaging lens 12 includes an objective lens 30, a focus lens 31, a rear end lens 32, and a stop 33. Each member is arranged in the order of the objective lens 30, the stop 33, the focus lens 31, and the rear end lens 32 from the objective side along an optical axis A of the imaging lens 12. The objective lens 30, the focus lens 31, and the rear end lens 32 constitute an optical system. The type, number, and arrangement order of the lenses constituting the optical system are not limited to the example illustrated in FIG. 1.

In addition, the imaging lens 12 includes a lens drive control unit 34. The lens drive control unit 34 includes, for example, a CPU, a RAM, a ROM, and the like. The lens drive control unit 34 is electrically connected to the processor 40 in the body 11.

The lens drive control unit 34 drives the focus lens 31 and the stop 33 based on a control signal transmitted from the processor 40. The lens drive control unit 34 performs drive control of the focus lens 31 based on a control signal for focusing control that is transmitted from the processor 40, in order to adjust a position of the focus lens 31.

The stop 33 has an opening in which an opening diameter is variable with the optical axis A as a center. The lens drive control unit 34 performs drive control of the stop 33 based on a control signal for exposure adjustment that is transmitted from the processor 40, in order to adjust an amount of light incident on a light-receiving surface 20A of an imaging sensor 20.

Further, the imaging sensor 20, the processor 40, and a memory 42 are provided inside the body 11. The operations of the imaging sensor 20, the memory 42, the operation unit 13, the finder 14, and the display 15 are controlled by the processor 40.

The processor 40 includes, for example, a CPU, a RAM, a ROM, and the like. In such a case, the processor 40 executes various types of processing based on a program 43 stored in the memory 42. Note that the processor 40 may be configured by an assembly of a plurality of IC chips. In addition, the memory 42 stores a machine-trained model LM that has been subjected to machine learning for detecting the subject.

The imaging sensor 20 is, for example, a CMOS-type image sensor. The imaging sensor 20 is disposed such that the optical axis A is orthogonal to the light-receiving surface 20A and the optical axis A is positioned at the center of the light-receiving surface 20A. Light (subject image) passing through the imaging lens 12 is incident on the light-receiving surface 20A. A plurality of pixels for generating imaging signals through photoelectric conversion are formed on the light-receiving surface 20A. The imaging sensor 20 generates and outputs image data PD including an imaging signal by photoelectrically converting light incident on each pixel.

In addition, a color filter array of a Bayer array is disposed on the light-receiving surface 20A of the imaging sensor 20, and a color filter of any one of red (R), green (G), or blue (B) is disposed to face each pixel. Note that some of the plurality of pixels arranged on the light-receiving surface of the imaging sensor 20 are phase-difference detection pixels that output a phase-difference detection signal for performing focusing control.

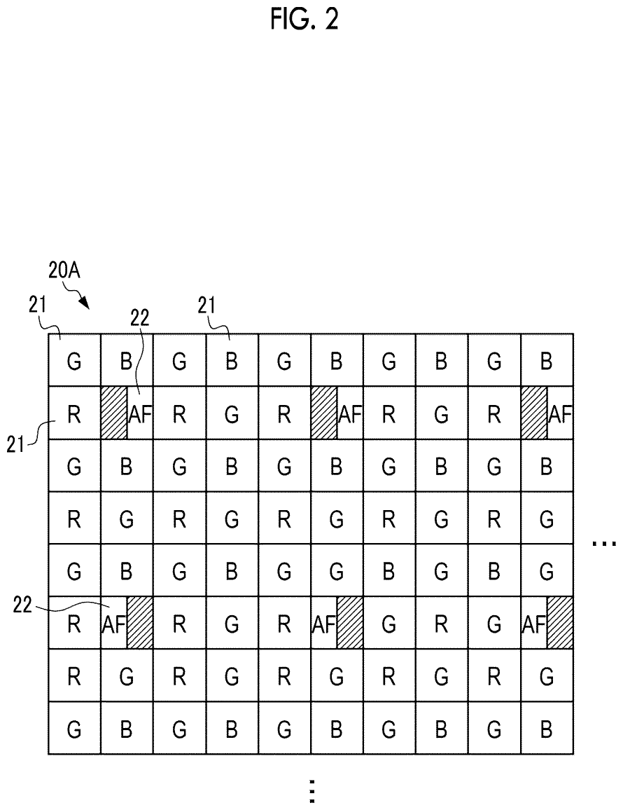

FIG. 2 illustrates an example of the light-receiving surface 20A of the imaging sensor 20. A plurality of imaging pixels 21 and a plurality of phase-difference detection pixels 22 are arranged on the light-receiving surface 20A. The imaging pixel 21 is a pixel in which the color filter is disposed. The imaging pixel 21 receives a luminous flux passing through the entire region of an exit pupil of the imaging optical system. The phase-difference detection pixel 22 receives a luminous flux passing through a region of the half of the exit pupil of the imaging optical system. In the example illustrated in FIG. 2, some of the G pixels that are diagonally disposed are replaced with the phase-difference detection pixels 22 in the Bayer array. The phase-difference detection pixels 22 are disposed on the light-receiving surface 20A at regular intervals in a vertical direction and a horizontal direction. The phase-difference detection pixels 22 are divided into first phase-difference detection pixels that receive a luminous flux passing through a region of the half of the exit pupil and second phase-difference detection pixels that receive a luminous flux passing through a region of the other half of the exit pupil.

The plurality of imaging pixels 21 output an imaging signal for generating an image of the subject. The plurality of phase-difference detection pixels 22 output a phase-difference detection signal. The image data PD output from the imaging sensor 20 includes the imaging signal and the phase-difference detection signal.

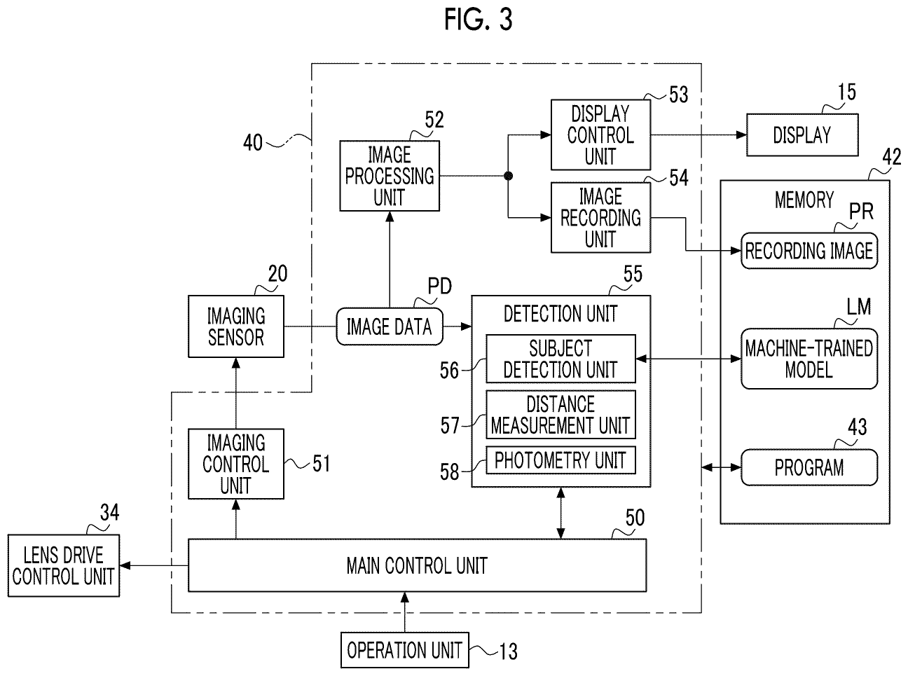

FIG. 3 illustrates an example of a functional configuration of the processor 40. The processor 40 implements various functional units by executing processing in accordance with the program 43 stored in the memory 42. As illustrated in FIG. 3, for example, the processor 40 implements a main control unit 50, an imaging control unit 51, an image processing unit 52, a display control unit 53, an image recording unit 54, and a detection unit 55. In the present embodiment, the detection unit 55 includes a subject detection unit 56, a distance measurement unit 57, and a photometry unit 58. The subject detection unit 56 operates in a case where the subject automatic detection mode is set. The distance measurement unit 57 and the photometry unit 58 are operated in a case where the AF mode is set.

The main control unit 50 comprehensively controls operations of the imaging apparatus 10 based on command signals input from the operation unit 13. The imaging control unit 51 executes imaging processing of causing the imaging sensor 20 to generate the image data PD by controlling the imaging sensor 20. The imaging control unit 51 drives the imaging sensor 20 in the still image imaging mode or the video imaging mode. The imaging sensor 20 outputs the image data PD generated by performing imaging via the imaging lens 12. The image data PD output from the imaging sensor 20 is supplied to the image processing unit 52 and the detection unit 55.

The image processing unit 52 acquires the image data PD output from the imaging sensor 20, and performs, on the image data PD, image processing including white balance adjustment, gamma-correction processing, and the like.

The display control unit 53 displays, on the display 15, a live view image based on the image data PD obtained by performing image processing by the image processing unit 52. The image recording unit 54 records, as a recording image PR, the image data PD that is obtained by performing image processing by the image processing unit 52 in the memory 42 in a case where the release button is fully pressed.

The subject detection unit 56 reads the machine-trained model LM stored in the memory 42 and performs detection processing of detecting all the subjects that are reflected in the image data PD and detectable by using the machine-trained model LM. The machine-trained model LM is configured by, for example, a convolutional neural network.

The machine-trained model LM is generated by performing machine learning on a machine learning model by using a large number of training data in a learning phase. The machine learning model obtained by performing machine learning in the learning phase is stored in the memory 42, as the machine-trained model LM. Note that the learning processing of the machine learning model is performed by, for example, an external device.

The machine-trained model LM is not limited to a model configured as software, and may be configured by hardware such as an IC chip. In addition, the machine-trained model LM may be configured by an assembly of a plurality of IC chips.

The subject detected by the subject detection unit 56 is a human, an animal (a dog, a cat, or the like), a bird, a train, a car, or the like. The subject includes parts such as a face and a pupil. In the present disclosure, a subject other than a human or a part thereof is referred to as a first subject, and a human or a part thereof is referred to as a second subject. The first subject and the second subject are different types of subjects.

The distance measurement unit 57 selects a subject (first subject or second subject) closest to the currently set AF area as an AF target from the plurality of subjects detected by the subject detection unit 56. In a case in which the AF area is not set by the user, the distance measurement unit 57 selects the subject existing in the vicinity of the center of the image data PD as the AF target. In addition, the distance measurement unit 57 may select the subject present in the vicinity of the center of the image data PD as the AF target regardless of the position of the AF area.

The distance measurement unit 57 detects a distance measurement value indicating a distance from the imaging sensor 20 to the AF target. Specifically, the distance measurement unit 57 acquires the phase-difference detection signal from the region corresponding to the AF target of the image data PD output from the imaging sensor 20, and outputs the distance obtained based on the acquired phase-difference detection signal as a distance measurement value. The distance measurement value corresponds to a defocusing amount representing the amount of deviation from the focus position of the focus lens 31.

The photometry unit 58 selects an AE target from the plurality of subjects detected by the subject detection unit 56 and calculates a photometric value for exposure adjustment based on brightness of the AE target. The photometry unit 58 selects the second subject as the AE target in principle. In a case in which the plurality of subjects detected by the subject detection unit 56 do not include the second subject, the photometry unit 58 selects, as the AE target, the first subject selected by the distance measurement unit 57 as the AF target.

The photometry unit 58 calculates a photometric value for exposure adjustment based on the image data PD output from the imaging sensor 20. In the present embodiment, the photometry unit 58 calculates a photometric value (hereinafter, referred to as a full screen photometric value) with respect to the entire image data PD and a photometric value (hereinafter, referred to as a subject photometric value) with respect to the subject which is an AE target, and calculates a photometric value for exposure adjustment by increasing the weighting of the subject photometric value with respect to the full screen photometric value.

The main control unit 50 performs focusing processing for setting the subject, which is the AF target, to a focusing state by moving the focus lens 31 through the lens drive control unit 34 based on the distance measurement value detected by the distance measurement unit 57. As described above, in the present embodiment, focusing control using a phase difference detection method is performed.

In addition, the main control unit 50 performs adjustment processing of setting the brightness of the AE target to be within the appropriate range by changing at least one of the F number or the shutter speed based on the photometric value for exposure adjustment calculated by the photometry unit 58. For example, the main control unit 50 changes the F number by controlling the stop 33 through the lens drive control unit 34. In addition, the main control unit 50 changes the shutter speed by controlling the imaging sensor 20 via the imaging control unit 51. Since the photometry unit 58 calculates the photometric value for exposure adjustment based on the full screen photometric value and the subject photometric value having a larger weighting than the full screen photometric value, the brightness of the entire screen is also set to be within the appropriate range while the brightness of the AE target is given priority to be within the appropriate range.

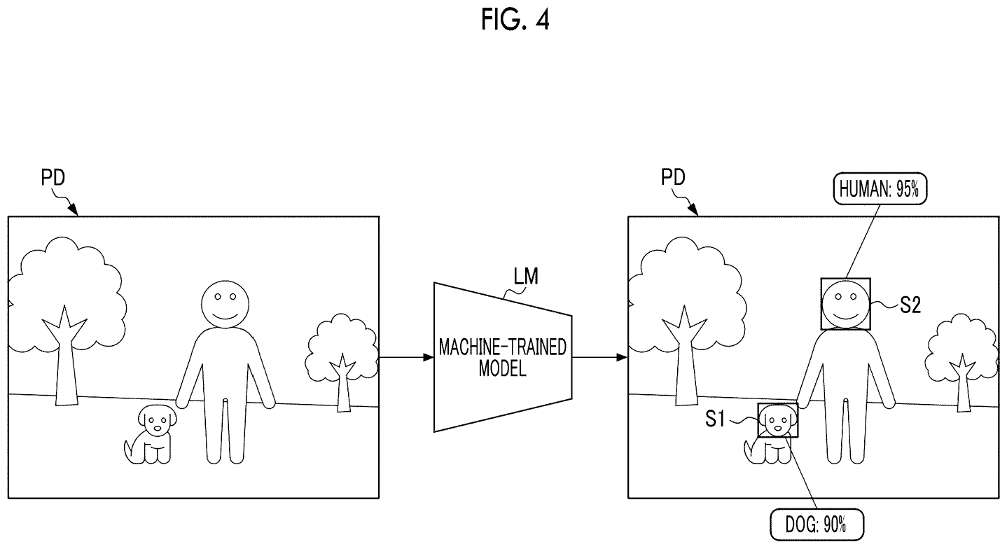

FIG. 4 conceptually illustrates an example of processing by the machine-trained model LM. The image data PD is input to the machine-trained model LM. The machine-trained model LM detects all the subjects reflected in the image data PD and outputs detection information of the subject together with a type of the detected subject and a detection score. In the example illustrated in FIG. 4, two subjects of “dog face” and “human face” are detected from the image data PD. In addition, in the example illustrated in FIG. 4, the “dog face” is detected as the first subject S1, and the “human face” is detected as the second subject S2.

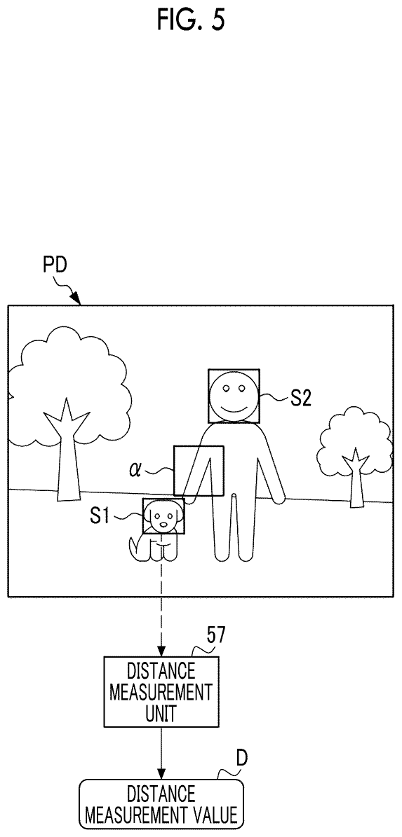

FIG. 5 is a diagram conceptually illustrating an example of processing by a distance measurement unit 57. In the example illustrated in FIG. 5, the distance measurement unit 57 selects the first subject S1 closest to the currently set AF area a as the AF target, and detects the distance measurement value D representing the distance from the imaging sensor 20 to the first subject S1.

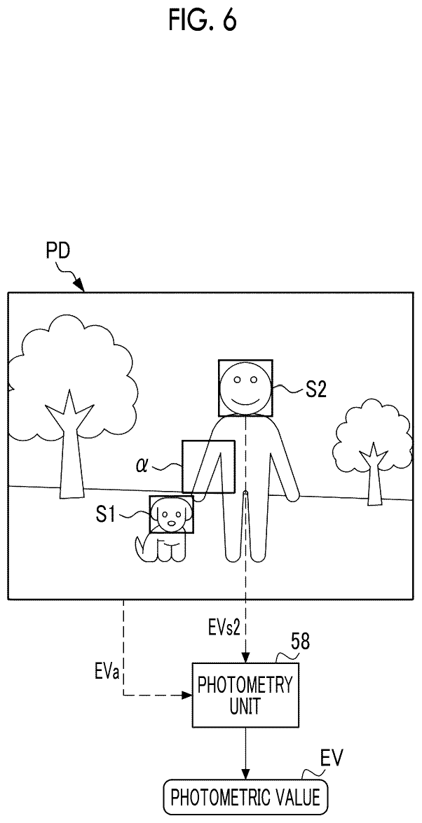

FIG. 6 is a diagram conceptually illustrating an example of processing by a photometry unit 58. In the example illustrated in FIG. 6, the photometry unit 58 selects the second subject S2, which is not the AF target, as the AE target. The photometry unit 58 calculates the full screen photometric value EVa and the subject photometric value EVs2 and then calculates the photometric value EV for exposure adjustment using Equation (1).

$${2}^{EV} = ( 1 - w ) \times {2}^{EVa} + w \times {2}^{EVs 2} \qquad ( 1 )$$

Here, w is a weight and is a value satisfying 0.5<w<1.

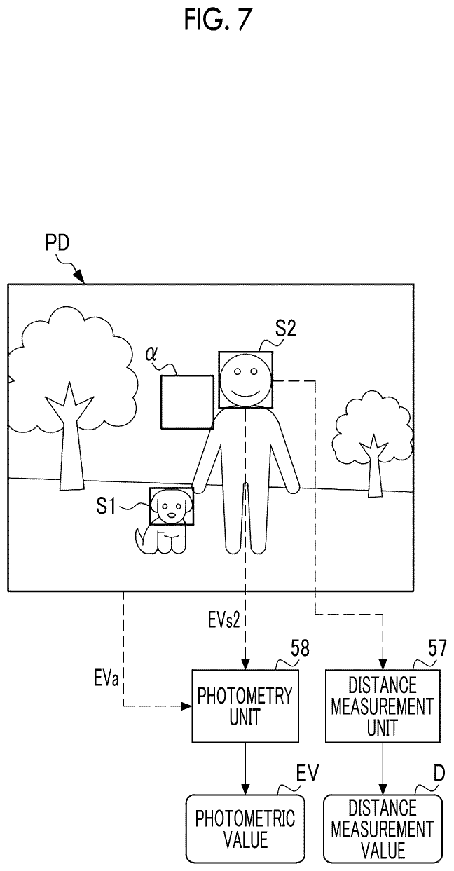

FIG. 7 is a diagram conceptually illustrating an example of processing in a case in which a second subject S2 is selected as an AF target and an AE target. As illustrated in FIG. 7, in a case in which the subject closest to the currently set AF area a is the second subject S2, the distance measurement unit 57 selects the second subject S2 as the AF target, and detects the distance measurement value D representing the distance from the imaging sensor 20 to the second subject S2. In this case, the photometry unit 58 selects the second subject S2, which is the AF target, as the AE target, and calculates the photometric value EV for exposure adjustment.

As described above, the distance measurement unit 57 selects the subject (the first subject S1 or the second subject S2) closest to the AF area a intended by the user as the AF target, but the photometry unit 58 selects the second subject S2 as the AE target with priority. This is because, in a case in which the subject selected as the AF target is directly set as the AE target, the first subject S1 such as a dog has a large number of color types and thus it is difficult to perform the exposure adjustment. For example, in a case where the first subject S1 is a black dog, it is difficult to determine whether or not the photometric value is low because the color is black or the brightness is low, and the exposure may be overexposed as a result of the exposure adjustment. On the other hand, the human face and the like have a small number of color types. Therefore, by setting the second subject S2 as the AE target, the accuracy of the exposure adjustment is improved.

An imaging method of the present disclosure includes a first focusing step of focusing on a first subject S1, a second focusing step of focusing on a second subject S2, and a selection step of selecting the first focusing step or the second focusing step, and performs exposure adjustment based on brightness of the second subject S2 in a case in which any of the first focusing step or the second focusing step is selected.

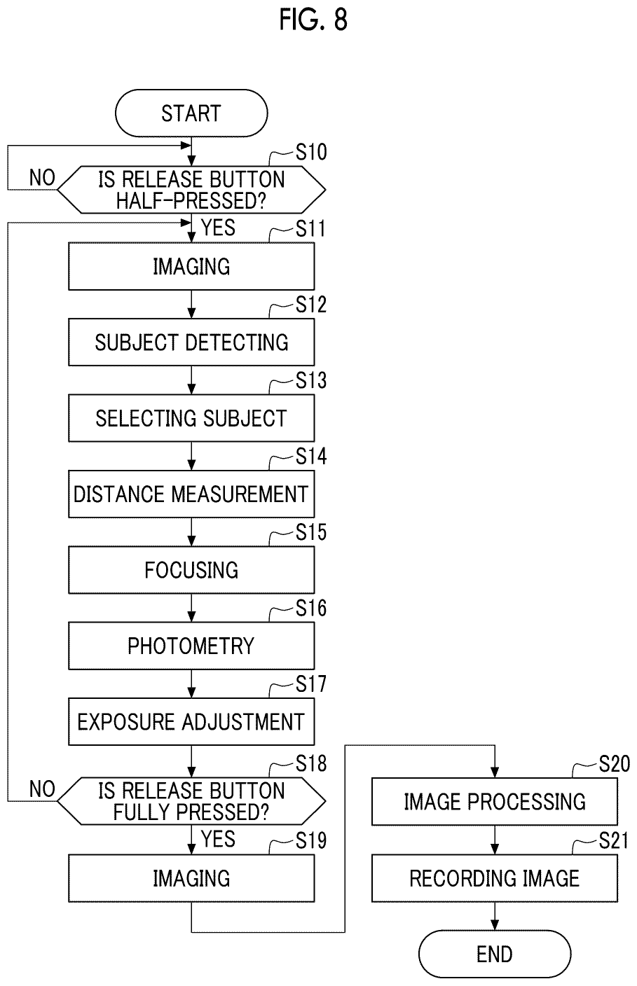

FIG. 8 is a flowchart illustrating an example of an imaging operation by the imaging apparatus 10. FIG. 8 illustrates a case where the subject automatic detection mode is set in the AF mode.

First, the main control unit 50 determines whether or not the release button is half-pressed by the user (step S10). In a case where the release button is half-pressed (YES in step S10), the main control unit 50 controls the imaging control unit 51 to cause the imaging sensor 20 to perform an imaging operation (step S11). The image data PD output from the imaging sensor 20 is input to the detection unit 55.

The subject detection unit 56 performs detection processing of detecting all the subjects that are reflected in the image data PD and detectable by using the machine-trained model LM (step S12).

The distance measurement unit 57 performs selection processing of selecting the subject (first subject or second subject) closest to the currently set AF area a as the AF target from the plurality of subjects detected by the subject detection unit 56 (step S13). Then, the distance measurement unit 57 detects a distance measurement value indicating the distance to the subject selected as the AF target (step S14). The main control unit 50 performs the above-mentioned focusing processing based on the distance measurement value detected by the distance measurement unit 57 (step S15).

The photometry unit 58 selects the second subject as the AE target and calculates a photometric value for exposure adjustment based on the brightness of the second subject (step S16). The main control unit 50 performs the adjustment processing described above based on the photometric value for exposure adjustment calculated by the photometry unit 58 (step S17).

The main control unit 50 determines whether or not the release button is fully pressed by the user (step S18). In a case where the release button is not fully pressed (that is, in a case where half-pressing of the release button is continued) (NO in step S18), the main control unit 50 returns the processing to step S11, and causes the imaging sensor 20 to perform an imaging operation again. The processing of steps S11 to S17 is repeatedly executed until the main control unit 50 determines in step S18 that the release button is fully pressed.

In a case where the release button is fully pressed (YES in step S18), the main control unit 50 causes the imaging sensor 20 to perform an imaging operation (step S19). The image processing unit 52 performs image processing on the image data PD output from the imaging sensor 20 (step S20). The image recording unit 54 records the image data PD subjected to the image processing by the image processing unit 52 in the memory 42 as the recording image PR (step S21).

In the flowchart, step S11 corresponds to an “imaging step” according to the technology of the present disclosure. Step S12 corresponds to a “detection step” according to the technology of the present disclosure. Step S13 corresponds to a “determination step” according to the technology of the present disclosure. Steps S14 and S15 correspond to a “focusing step” according to the technology of the present disclosure. Steps S16 and S17 correspond to an “adjustment step” according to the technology of the present disclosure.

As described above, according to the imaging apparatus 10 according to the present embodiment, the first subject and the second subject are detected from the image data, and in a case of focusing on the first subject, the exposure adjustment is performed based on the brightness of the second subject. Therefore, the accuracy of the imaging adjustment is improved.

Hereinafter, various modification examples of the embodiment will be described.

In the above-described embodiment, the photometry unit 58 calculates the photometric value EV for exposure adjustment based on the full screen photometric value EVa and the subject photometric value EVs2 of the second subject S2. Alternatively, the photometry unit 58 may calculate the photometric value EV for exposure adjustment using Equation (2) based on the full screen photometric value EVa, the subject photometric value EVs2 of the second subject S2, and the subject photometric value EVs1 of the first subject S1.

$${2}^{EV} = ( 1 - {w}_{1} - {w}_{2} ) \times {2}^{EVa} + {w}_{1} \times {2}^{EVs 1} + {w}_{2} \times {2}^{EVs 2} \qquad ( 2 )$$

Here, w₁ and w₂ are weights, and satisfy a relationship of w₁<w₂.

That is, in the adjustment step, the exposure may be adjusted by giving priority to the brightness of the second subject over the brightness of the first subject, based on the brightness of the first subject and the second subject.

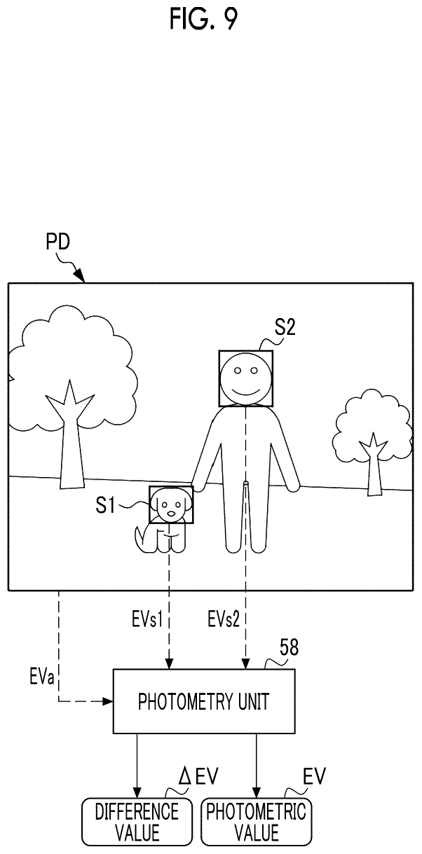

Further, in a case of adjusting the exposure based on the brightness of the first subject and the second subject, the exposure may be adjusted such that a difference between the brightness of the first subject and the brightness of the second subject after the exposure adjustment is within a predetermined range. In this case, as illustrated in FIG. 9, the photometry unit 58 calculates the full screen photometric value EVa, the subject photometric value EVs2 of the second subject S2, and the subject photometric value EVs1 of the first subject S1, and calculates the photometric value EV for exposure adjustment based on the Equation (2). In addition, the photometry unit 58 calculates a difference value ΔEV between the subject photometric value EVs2 and the subject photometric value EVs1. For example, the difference value ΔEV is an absolute value of a difference between the subject photometric value EVs2 and the subject photometric value EVs1.

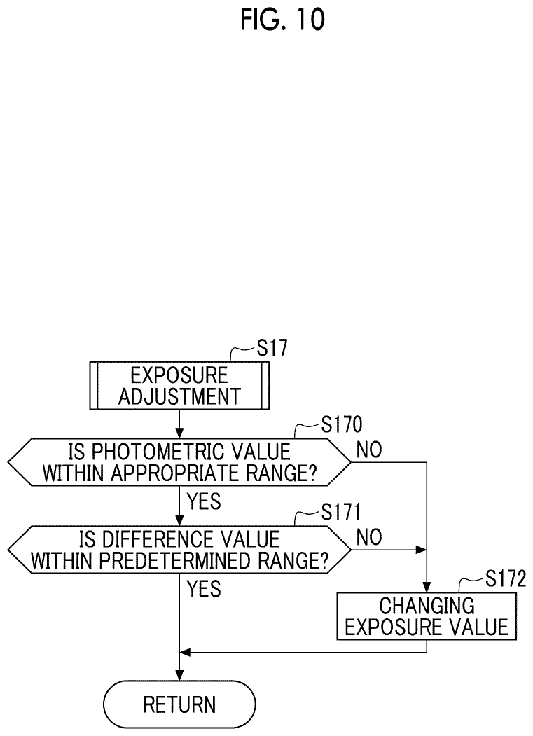

FIG. 10 illustrates adjustment processing according to the modification example. In the present modification example, the main control unit 50 determines whether or not the photometric value EV calculated by the photometry unit 58 is within the appropriate range (step S170). In a case where the photometric value EV is within the appropriate range (YES in step S170), the main control unit 50 determines whether or not the difference value ΔEV is within the predetermined range (step S171).

In a case where the photometric value EV is not within the appropriate range (NO in step S170) or in a case where the difference value ΔEV is not within the predetermined range (NO in step S171), the main control unit 50 changes the exposure value by changing at least any one of the F number or the shutter speed (step S172). In a case where the difference value ΔEV is within the predetermined range (YES in step S171), the main control unit 50 ends the process.

In the above-described embodiment, the exposure adjustment is performed based on the brightness of the second subject, but instead of this or in addition to this, it may be determined whether or not the imaging environment is the specific imaging environment based on the brightness of the second subject. The phrase “determined whether or not the imaging environment is the specific imaging environment” includes indirectly determining whether or not the imaging environment is the specific imaging environment from the subject recognition, the full screen photometric value EVa, the subject photometric value EVs, or the like. For example, it may be determined whether or not the imaging environment is a backlight based on the brightness of the second subject.

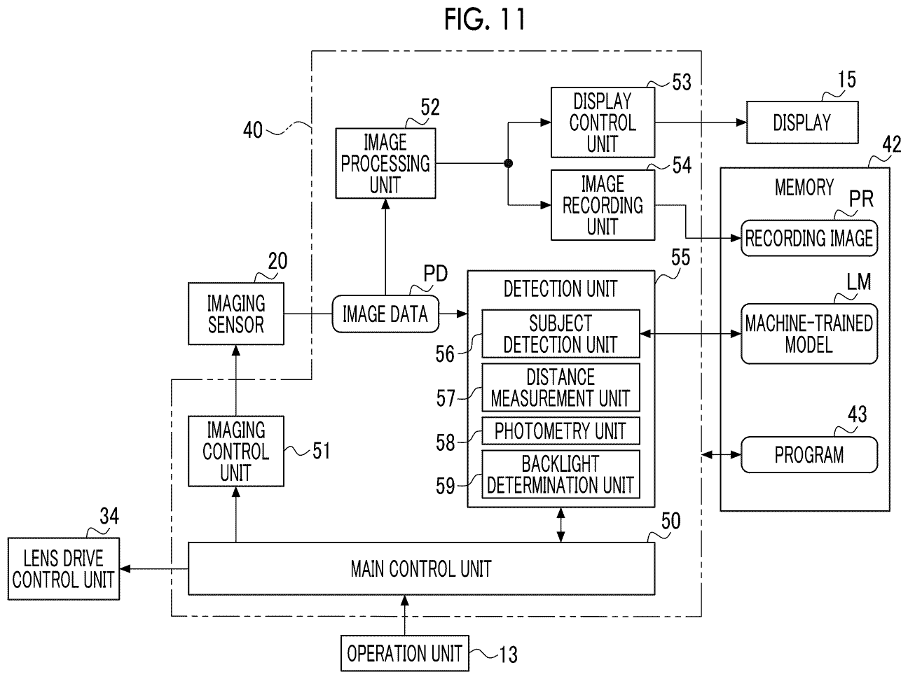

FIG. 11 illustrates a functional configuration of a processor 40 according to the modification example. In the present modification example, the configuration is different from that of the above-described embodiment in that a backlight determination unit 59 is provided in the detection unit 55 in addition to the subject detection unit 56, the distance measurement unit 57, and the photometry unit 58.

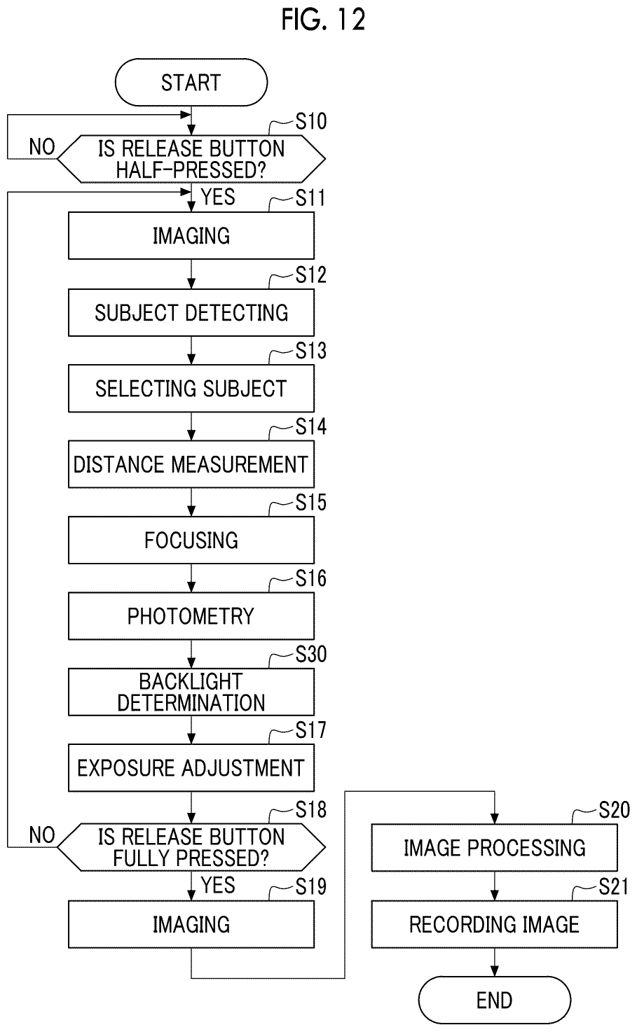

FIG. 12 is a flowchart illustrating an example of an imaging operation by the imaging apparatus 10 according to the modification example. The imaging operation of the present modification example is different from the imaging operation of the above embodiment in that the determination processing (step S30) by the backlight determination unit 59 is performed after step S16. Step S30 corresponds to a “determination step” according to the technology of the present disclosure. The determination step is included in the adjustment step.

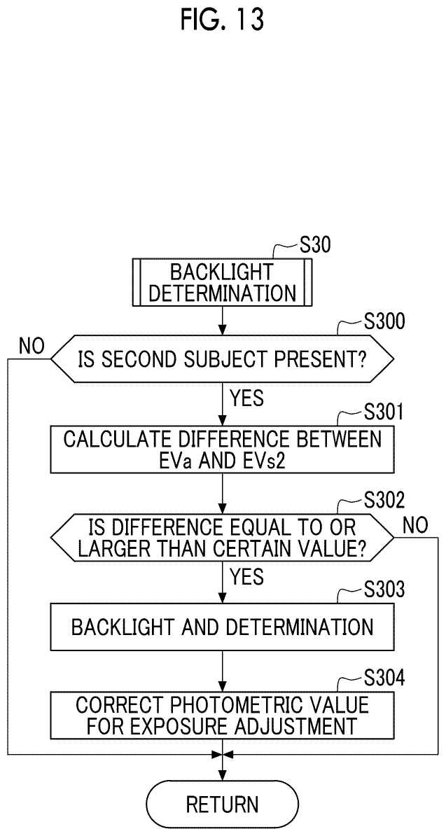

FIG. 13 illustrates an example of determination processing by the backlight determination unit 59. First, the backlight determination unit 59 determines whether or not the second subject is present in the plurality of subjects detected by the subject detection unit 56 (step S300). In a case where the second subject is not present (NO in step S300), the process ends without performing the determination processing.

In a case where the second subject is present (YES in step S300), the backlight determination unit 59 calculates a difference between the full screen photometric value EVa and the subject photometric value EVs2 calculated by the photometry unit 58 (step S301). Then, the backlight determination unit 59 determines whether or not the calculated difference is equal to or larger than a certain value (step S302). In a case where the difference is not equal to or larger than the certain value (NO in step S302), the backlight determination unit 59 ends the process.

In a case where the difference is equal to or larger than the certain value (YES in step S302), the backlight determination unit 59 determines that the imaging environment is the backlight (step S303). Then, the backlight determination unit 59 corrects the photometric value EV for exposure adjustment by increasing the weight w in Equation (1) (step S304).

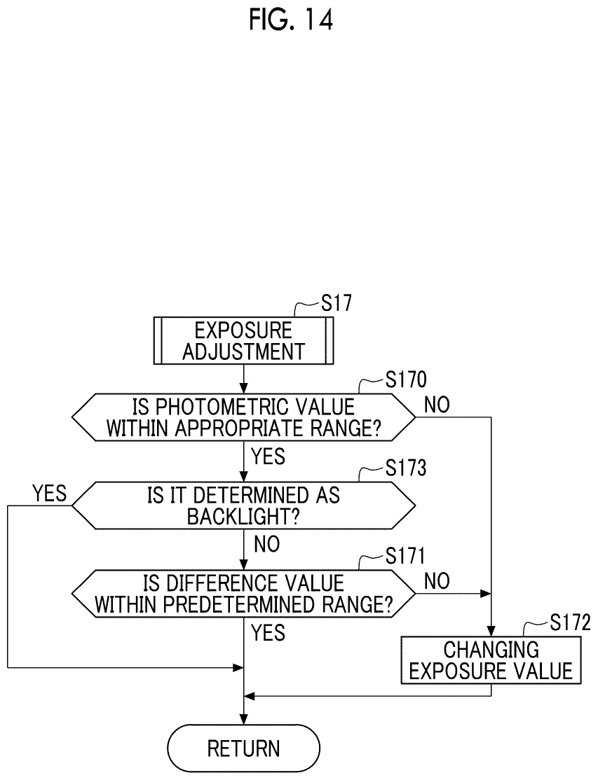

FIG. 14 illustrates an example of adjustment processing in a case of performing backlight determination. The point that step S173 is added between step S170 and step S171 is different from the adjustment processing illustrated in FIG. 10. In the present modification example, in a case where the photometric value EV is within the appropriate range (YES in step S170), the main control unit 50 determines whether or not the backlight is determined by the backlight determination unit 59 (step S173). In a case where the backlight is not determined by the backlight determination unit 59 (NO in step S173), the main control unit 50 determines whether or not the difference value ΔEV is within the predetermined range (step S171). In a case where the backlight is determined by the backlight determination unit 59 (YES in step S173), the main control unit 50 ends the process.

That is, in the present modification example, in a case where the imaging environment is the backlight, the exposure adjustment based on the brightness of the second subject is preferentially performed rather than setting the difference between the brightness of the first subject and the brightness of the second subject to be within the predetermined range.

By performing the backlight determination as described above, and performing the exposure adjustment by increasing the weighting for the second subject in a case of the backlight, it is possible to suppress the whiteout or the blooming of the second subject.

In the embodiment described above, the case where one second subject in addition to the first subject is detected by the subject detection unit 56 has been described as an example. Meanwhile, in a case where a plurality of second subjects are detected, the photometry unit 58 may select the brightest second subject or the darkest second subject as the AE target based on the brightness of each second subject. In addition, in a case where a plurality of second subjects are detected, the photometry unit 58 may select the AE target based on the size of the second subject. Further, the photometry unit 58 may calculate the photometric value EV for exposure adjustment by setting the plurality of second subjects as the AE targets and using the value obtained by performing weighted averaging on the photometric values of the plurality of second subjects as the above-described subject photometric value EVs2. For example, the photometric value of the second subject may be weighted and averaged such that the weight is increased in the order of the photometric values of the second subjects close to the photometric value of the first subject which is the AF target.

In the above-described embodiment, the exposure adjustment is performed based on the brightness of the second subject, but the technology of the present disclosure is not limited to the brightness of the second subject and can be applied to an imaging apparatus that performs the imaging adjustment in the imaging step based on the state of the second subject.

For example, the technology of the present disclosure can be applied to an imaging apparatus comprising a so-called film simulation function of determining an imaging scene and adjusting a tone of image data PD based on the determined imaging scene. In this case, the detection unit 55 determines the imaging scene by analyzing the image data PD. Specifically, the detection unit 55 determines the imaging scene (landscape, portrait, indoor, night view, and the like) with the presence of the second subject as one condition. The image processing unit 52 changes the tone of the image data PD in accordance with the imaging scene determined by the detection unit 55. The changing of the tone means changing gradation, contrast, chroma saturation, and the like.

In addition, the technology of the present disclosure can be applied to adjustment of white balance, dynamic range, and the like. By adjusting the white balance, the dynamic range, and the like for a second subject different from the first subject selected as the AF target, the adjustment accuracy is improved.

### Other Modification Examples

In the embodiment described above, the subject detection unit 56 performs the detection processing using the machine-trained model LM, but is not limited to the machine-trained model LM, and may perform the detection processing by image analysis using an algorithm.

In the above embodiment, the focusing control is performed by moving the focus lens 31, but the present disclosure is not limited to this, and the focusing control may be performed by changing the thickness of the focus lens 31, moving the imaging sensor 20, or the like.

Note that the technology of the present disclosure is not limited to the digital camera and can also be applied to electronic devices such as a smartphone and a tablet terminal having an imaging function.

In the above-described embodiment, various processors to be described below can be used as the hardware structure of the control unit using the processor 40 as an example. The above-described various processors include not only a CPU which is a general-purpose processor that functions by executing software (programs) but also a processor that has a changeable circuit configuration after manufacturing, such as an FPGA. The FPGA includes a dedicated electrical circuit that is a processor which has a dedicated circuit configuration designed to execute specific processing, such as PLD or ASIC, and the like.

The control unit may be configured by one of these various processors or a combination of two or more of the processors of the same type or different types (for example, a combination of a plurality of FPGAs or a combination of a CPU and an FPGA). Alternatively, a plurality of control units may be configured with one processor.

A plurality of examples in which a plurality of control units are configured as one processor can be considered. As a first example, there is an aspect in which one or more CPUs and software are combined to configure one processor and the processor functions as a plurality of control units, as represented by a computer such as a client and a server. As a second example, there is an aspect in which a processor that implements the functions of the entire system, which includes a plurality of control units, with one IC chip is used, as represented by system on chip (SOC). In this way, the control unit can be configured by using one or more of the above-described various processors as the hardware structure.

As a hardware structure of these various processors, more specifically, an electrical circuit in which circuit elements such as semiconductor elements are combined can be used.

Further, the technology of the present disclosure extends to a computer-readable storage medium that non-transitorily stores the program, in addition to the program.

The described contents and the illustrated contents are the detailed description of the parts according to the technology of the present disclosure, and are merely examples of the technology of the present disclosure. For example, the descriptions related to the configuration, the function, the operation, and the effect are descriptions related to examples of a configuration, a function, an operation, and an effect of a part according to the technique of the present disclosure. Therefore, it goes without saying that, in the described contents and illustrated contents, unnecessary parts may be deleted, new components may be added, or replacements may be made without departing from the spirit of the technique of the present disclosure. Further, in order to avoid complications and facilitate understanding of the part according to the technique of the present disclosure, in the described contents and illustrated contents, descriptions of technical knowledge and the like that do not require particular explanations to enable implementation of the technique of the present disclosure are omitted.

All documents, patent applications, and technical standards described in this specification are incorporated herein by reference to the same extent as in a case where each document, each patent application, and each technical standard are specifically and individually described by being incorporated by reference.

What is claimed is:

1. An imaging method comprising:
an imaging step of generating image data by performing imaging through an imaging lens;
a detection step of detecting a first subject and a second subject from the image data;
a first focusing step of focusing on the first subject; and
an adjustment step of performing imaging adjustment in the imaging step based on a state of the second subject.

2. The imaging method according to claim 1, wherein
the state is brightness, and
in the adjustment step, exposure is adjusted.

3. The imaging method according to claim 2, wherein
the adjustment step includes a determination step of determining whether or not an imaging environment is a specific imaging environment based on the brightness of the second subject, and
in the adjustment step, the exposure is adjusted based on a determination result in the determination step.

4. The imaging method according to claim 2, wherein
in the adjustment step, the exposure is adjusted by prioritizing the brightness of the second subject over brightness of the first subject.

5. The imaging method according to claim 2, wherein
in the adjustment step, the exposure is adjusted such that a difference between brightness of the first subject and the brightness of the second subject after the exposure adjustment is within a predetermined range.

6. The imaging method according to claim 1, wherein
in the adjustment step, a tone of the image data is adjusted.

7. The imaging method according to claim 1, wherein
in the detection step, the first subject and the second subject are detected by using a machine-trained model.

8. The imaging method according to claim 1, wherein
the first subject and the second subject are subjects of different types.

9. The imaging method according to claim 8, wherein
the second subject is a human, and the first subject is a subject other than the human.

10. The imaging method according to claim 1, further comprising:
a second focusing step of focusing on the second subject; and
a selection step of selecting the first focusing step or the second focusing step, wherein
in the adjustment step, the imaging adjustment is performed based on the state of the second subject even in a case where any of the first focusing step or the second focusing step is selected.

11. An imaging apparatus comprising:
a processor, wherein
the processor performs
imaging processing of generating image data by performing imaging through an imaging lens,
detection processing of detecting a first subject and a second subject from the image data,
first focusing processing of causing the imaging lens to focus on the first subject, and
adjustment processing of performing imaging adjustment in the imaging processing based on a state of the second subject.

12. A non-transitory computer-readable storage medium storing a program causing a computer to execute:
imaging processing of generating image data by performing imaging through an imaging lens;
detection processing of detecting a first subject and a second subject from the image data;
first focusing processing of focusing on the first subject; and
adjustment processing of performing imaging adjustment in the imaging processing based on a state of the second subject.
